(19) United States
(12) Patent Application Publication
(10) Pub. No.: US 2024/0200832 A1
(43) Pub. Date: Jun. 20, 2024

(54) MINI SOLAR COOKER WITH HEAT STORAGE

(71) Applicant: Mohammad ARHAL, Marrakech (MA)

(72) Inventor: Mohammad ARHAL, Marrakech (MA)

(21) Appl. No.: 18/286,142

(22) PCT Filed: Feb. 10, 2022
(86) PCT No.: PCT/MA2022/000001

§ 371 Date: Oct. 9, 2023

(30) Foreign Application Priority Data
May 26, 2021 (MA) 53206

(51) Int. Cl. F24S 20/30; F24S 23/30; F24S 30/425; F24S 60/10

(52) U.S. Cl. CPC F24S 20/30; F24S 23/31; F24S 30/425; F24S 60/10

(57) ABSTRACT

The invention relates to a small solar cooker with thermal energy storage. The device comprises an insulated wall (11), a transparent surface (1), and a Fresnel lens (2). The focal length of the lens can be adjusted using an automatic mechanical system (3) (12) to follow the height of the sun. During pre-heating, the focal point (10) of the lens is located on a small copper reservoir (4) containing a phase-change material (6). This material is thermally recharged by two methods: the concentration of radiation by the lens and/or by an auxiliary resistor supplied by an alternating current (5). The heat accumulated in the small reservoir allows the oven to be used when the sun is not shining or to reduce the cooking time. The whole oven is linked to another automatic mechanical system to follow the path of the sun.

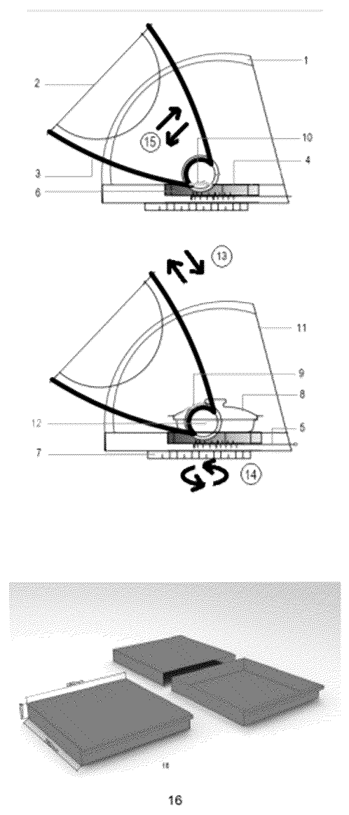

The present invention relates to the field of solar cooking of food, it is a small solar oven equipped with a small tank to store the heat in order to use it when the sun is out or to reduce the cooking time.

Currently the long cooking time is the main drawback of solar ovens with box (2 to 3 hours) in addition they do not take advantage of the preheating time enough which is an important step in reducing the cooking time. In addition, these ovens need to occupy more space in order to collect enough solar radiation which makes it difficult to use and move.

In order to reduce the long cooking time while reducing the size of the oven, a small copper tank (4) has been designed containing a phase change material (6) which allows the operation of heat storage when preheating the oven, this operation requires a period of time varies from 30 min to an hour and more, and this to reuse it during cooking, said reservoir (4) is fed by radiation via the focal point (10) created by the Fresnel lens, as well as by an auxiliary resistor supplied by a current alternative (5).

The means of collection and concentration of radiation consists of:
A PMMA Fresnel lens (2) with a focal length of 25 cm, it concentrates solar radiation on the tank (4) and on the lid of the container (8) after adjusting the focal length, by manually moving and vertically the lens 13. Said lens (2) is movable via a mechanical system automatic (3) and (12)
A transparent surface (1) consisting of two separate curved Plexiglas layers by air space or vacuum, this element allows solar radiation to easily penetrate inside the oven while preventing infrared rays emitted from the inside to go out (principle of the greenhouse effect) and it is also a good insulation to maintain the heat inside the oven

The reception of the radiation is done by:
A round-shaped copper reservoir (4) filled with a Phase Change Material (6), heat is absorbed or released as the material changes from solid to liquid and vice versa or when the internal structure of the material changes.

The PCM is hence called heat storage material, allows to store the heat during preheating in order to reuse it later during cooking.
A container in the form of a copper tajine (8) or a copper box (16) placed on the reservoir on the tank, the cover of which is enameled black to avoid oxidation of the copper as it is subjected to a focal point temperature of up to 280° C. the focal point (9) is formed on the hermetic lid of the tagine or tin, the heat begins to spread through them by conduction, they also receive already stored in the reservoir (4), so the cooking time of the food is reduced. cooking time is reduced.

The AC-powered auxiliary heater (5) operates when the sun is not shining. It is located in contact with and below the tank (4) containing the MCP (6), It can be used both for direct cooking and to supply the tank (4).

Two electronic mechanical systems have been designed to track the height and path of the sun in order to obtain an optimum concentration of radiation, as well as maintain the creation of focal points (10) and (9) during preheating and cooking
The first system (12) is connected to the support (3) of the lens (2) and its purpose is to control the movement that automatically follows the height of the sun 15
The second system (7) controls the movement of the entire oven to automatically follow the path of the sun 14

Concentrating on the lens, the storage and the monitoring system, these three elements enable the oven to perform at its best while taking up a minimum of space.

1- A solar cooker consisting of an insulated wall (11), a transparent surface (1), characterized a Fresnel lens (2) with a focal length of 250 mm, movable by means of one or two supports (3), the latter linked to an electronic mechanical system (12) to automatically track the height of the sun. During pre-heating, the focal point (10) of the lens (2) located on the small copper tank (4) containing a phase-change material (6), the latter is thermally charged by two methods: the concentration of radiation by the lens (2) and/or by an auxiliary resistor supplied by an alternating current (5), the heat accumulated in the small tank (4) enables the oven to be used when the sun is absent or to reduce the cooking time. During cooking, the container (8) or (16) receives heat by conduction via the small reservoir (4) already heated and/or by radiation via the focal point (9) located on its lid. The assembly is linked to an electronic mechanical system (7) to automatically follow the path of the sun.

2- Oven according to claim 1, characterised in that the insulated wall (11) is made of polyurethane.

3- Oven as claimed in claim 1, characterised in that the transparent surface (1) consists of two curved layers of plexiglass separated by an air space or by a vacuum.

4- Oven as claimed in claim 1, characterised in that the focal point of the lens can be located both on the tank and on the lid of the container after adjustment 13 of the focal distance.

5- Oven as claimed in claim 1, characterised in that the container may be in the form of a copper tagine, the lid of which must be hermetically sealed and enameled in lead-free black. or in the form of a square or rectangular copper can (16) which slides horizontally inside its lid, which must be airtight and enameled black lead-free.

6- Oven as claimed in claim 1, characterised in that the auxiliary heating element (5) is located above the tank and in contact with the tank.
